(19) United States
(12) Patent Application Publication
(10) Pub. No.: US 2005/0136773 A1
(43) Pub. Date: Jun. 23, 2005

(54) Treated nonwoven material

(75) Inventors: Ali Yahiaoui, Roswell, GA (US); Cliff J. Ellis, Woodstock, GA (US); Rasha W. Farag, Baldwin, GA (US); Sandra M. Rogers, Appleton, WI (US); Violet May Grube, Greenville, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/746,743

(22) Filed: Dec. 22, 2003

(51) Int. Cl. B32B 27/12

(52) U.S. Cl. 442/394; 442/327; 442/59

(57) ABSTRACT

A nonwoven material adapted for use as a surge layer or a transfer layer that includes a layer that includes fibers that have been treated with a polysaccharide, a modified polysaccharide, a derivative of a polysaccharide or a derivative of a modified polysaccharide is provided.

### CROSS-REFERENCE TO RELATED APPLICATIONS

This application is related to commonly assigned U.S. patent application Ser. No. ______, entitled “Porous Substrates Having One Side Treated At A Higher Concentration And Methods Of Treating Porous Substrates” filed by Express Mail Procedure EL 439721061 U.S. contemporaneously herewith and is hereby incorporated by reference herein.

### FIELD OF THE INVENTION

The present invention relates to nonwoven materials.

### BACKGROUND OF THE INVENTION

Conventional surge material is a material used in absorbent articles such as diapers to provide intake of fluid and some temporary storage before fluid is absorbed by an absorbent material or superabsorbent material. Many high-absorbency materials are unable to efficiently absorb a liquid at the rate at which liquid is applied to absorbent composites during use. Accordingly, a relatively high concentration of fibrous surge material is desirable to temporarily hold the liquid until the high-absorbency material can absorb it. Conventional surge material is also used to spread or distribute the fluid over more surface area of the absorbent material thereby increasing absorbency efficiency and material utilization efficiency.

By providing temporary storage of fluids the surge material keeps the fluid from returning, referred to as flowback, through a body-side liner of the diaper, or other absorbent article, and contacting the skin. The surge material increases absorption efficiency and decreases flowback caused by the slower-absorbing absorbent material. Examples of particular surge materials may be found in U.S. Pat. No. 5,490,846 to Ellis et al. and in U.S. Pat. No. 5,364,382 to Latimer et al.

There is a need for surge material with improved intake properties that can also reduce flowback and leakage of urine, or other fluid, from the absorbent article to the user's skin. Moreover, there is a need for a surge material that improves dryness in personal care absorbent articles such as diapers. Improved dryness can be measured by TransEpidermal Water Loss also referred to by the acronym TEWL. There is also a need to use less surfactants or surface active agents to treat surge materials so that the design absorbency characteristics of the superabsorbent material are not negatively affected. There is also a need to treat the surge material with compounds which have high affinity to tightly absorb aqueous base fluids and moisture in an enclosed diapered environment.

### SUMMARY OF THE INVENTION

Personal care absorbent articles such as diapers, training pants, incontinence garments, sanitary napkins, bandages and so forth are often required to accept quick, large insults of body exudates which are beyond the short term absorptive capacity of the product. As a result, it has been found advantageous to use surge layers within such personal care absorbent articles. Personal care absorbent articles generally have a fluid permeable body-side liner, also referred to as a top sheet, and a liquid impermeable backing layer with an absorbent core disposed therebetween. In one desirable embodiment, the present invention provides a fibrous nonwoven web which is particularly well suited for use as a surge layer or a transfer layer and is disposed between the body side-liner and the absorbent core. In addition, it is helpful if the surge layer of the present invention is attached to the liner and the absorbent core to promote liquid transfer.

In one embodiment, the present invention provides a nonwoven material adapted for use as a surge layer or a transfer layer that includes fibers that have been treated with a treatment composition comprising a polysaccharide, a modified polysaccharide, a derivative of a polysaccharide or a derivative of a modified polysaccharide, wherein the treatment composition on the surge layer reduces the surface tension of an aqueous fluid by less than about 20 dynes/cm as measured by ASTM Test Method D 1590-60. The nonwoven material may also further include second fibers that have not been treated with a polysaccharide, a modified polysaccharide, a derivative of a polysaccharide or a derivative of a modified polysaccharide. Desirably, at least a portion of the fibers are treated with a modified polysaccharide. In one embodiment, nonwoven fibers are included in a bonded, carded web having a basis weight in the range of from about 20 grams per square meter to about 150 grams per square meter and comprises greater than about 20 weight percent of the first fibers and greater than about 10 weight percent of the second fibers. In other embodiments, the nonwoven fibers include greater than about 30 weight percent of the first fibers and greater than about 20 weight percent of the second fibers; greater than about 40 weight percent of the first fibers treated and greater than about 30 weight percent of the second fibers and even greater than about 50 weight percent of the first fibers and greater than about 40 weight percent of the second fibers. In exemplary embodiments, the layer of nonwoven fibers consists essentially of from about 30 weight percent to about 80 weight percent of the first fibers and greater than about 20 weight percent to about 60 weight percent of the second fibers. The fibers can also be treated with a lubricant and/or an antistatic agent to ease the carding process. The fibers can be polyolefin fibers. In exemplary embodiments, the first fibers are bicomponent polyolefin fibers that include a polypropylene core and a polyethylene sheath or a polyethylene terephthalate core and a polyethylene sheath. Suggested polysaccharides, modified polysaccharides, derivatives of a polysaccharide and derivatives of a modified polysaccharide include modified celluloses, cellulose derivatives, hydroxyethyl cellulose, hydroxypropyl cellulose, methyl cellulose, ethyl cellulose, methyl hydroxypropyl cellulose, ethyl hydroxyethyl cellulose, carboxymethyl cellulose; starch derivatives, pectin derivatives, carboxymethyl starch, starch aldehyde, pectates, animal product derivatives, carboxymethyl chitin and carboxymethyl chitosan.

The present invention also provides personal care articles, for example a diaper, that includes a nonwoven material that includes fibers that have been treated with a treatment composition comprising a polysaccharide, a modified polysaccharide, a derivative of a polysaccharide or a derivative of a modified polysaccharide, wherein the treatment composition on the surge layer reduces the surface tension of an aqueous fluid by less than about 20 dynes/cm as measured by ASTM Test Method D 1590-60 as a surge layer or as a transfer layer. The present invention also provides a method of forming a layer of nonwoven fibers that includes: providing a plurality of first fibers treating the plurality of first fibers with a polysaccharide, a modified polysaccharide, a derivative of a polysaccharide or a derivative of a modified polysaccharide; providing a plurality of second fibers; combining the first fibers with the second fibers to form a mixture that comprises the first fibers and the second fibers; and forming a nonwoven web from the mixture that includes the first fibers and the second fibers. The method of forming a nonwoven web may include carding and bonding the first fibers and the second fibers to form a web.

In yet another embodiment, the present invention provides absorbent articles, such as diapers, that include a topsheet layer or other body contacting surface and an optional surge management layer that reduces the surface tension of distilled water by less than about 20 dynes as measured by ASTM Test Method D 1590-60. In certain embodiments, the diaper includes a surge layer or a transfer layer that includes fibers that have been treated with a treatment composition comprising a polysaccharide, a modified polysaccharide, a derivative of a polysaccharide or a derivative of a modified polysaccharide. In yet another embodiment, the present invention provides an absorbent article that includes: a porous, treated substrate comprising a first surface that comprises a first amount of a surfactant or mixture of surfactants and a second surface that comprises a second amount of the surfactant or the mixture of surfactants wherein the second amount of the surfactant or the mixture of surfactants is less than the first amount of the surfactant or the mixture of surfactants; and a layer of nonwoven fibers comprising fibers treated with a polysaccharide, a modified polysaccharide, a derivative of a polysaccharide or a derivative of a modified polysaccharide. In certain embodiments, the first surface of the porous, treated substrate is oriented toward or adjacent the layer of nonwoven fibers treated with a polysaccharide, a modified polysaccharide, a derivative of a polysaccharide or a derivative of a modified polysaccharide. The porous, treated substrate may further include a skin health agent. In certain embodiments, the nonwoven fibers are included in a spunbonded web that includes nonwoven fibers treated with ethyl hydroxyethyl cellulose, hydroxypropyl cellulose or a mixture thereof. In certain embodiments, the second surface of the porous, treated substrate comprises essentially no surfactant. In certain embodiments, the porous, treated substrate is a single layer. Desirably, the TEWL of the combination is less than the TEWL of the porous, treated substrate and the layer of nonwoven fibers.

Other features and aspects of the present invention are discussed in greater detail below.

### BRIEF DESCRIPTION OF THE DRAWINGS

A full and enabling disclosure of the present invention, including the best mode thereof directed to one of ordinary skill in the art, is set forth more particularly in the remainder of the specification, including reference to the accompanying figures in which:

FIG. 1 representatively shows a partially cutaway, top plan view of an absorbent article according to one embodiment of the invention; and

FIG. 2 representatively shows a sectional view of the absorbent article of FIG. 1 taken along line 2-2.

Repeated use of reference characters in the present specification and drawings is intended to represent same or analogous features or elements of the present invention.

Definitions

“Bonded carded web” refers to webs made from staple fibers which are sent through a combing or carding unit, which breaks apart and partially aligns the staple fibers in the machine direction to form a generally machine direction-oriented fibrous nonwoven web. Such fibers are usually purchased in bales which are placed in an opening and blending system which separates and blends the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

As used herein, “through-air bonding” or “TAB” means a process of bonding a nonwoven containing bicomponent fibers or a blend of fibers having differential melting points greater than 20° Fahrenheit in which air which is sufficiently hot to melt one of the polymers of which the fibers of the web are made is forced through the web. The hot air velocity and dwell time are sufficient to allow the lower melting polymer to flow such that at least a portion of the fibers become bonded at the points of fiber to fiber contact. The melting and resolidification of the polymer provides the bonding. Through air bonding (TAB) has relatively restricted variability and since through-air bonding requires the melting of at least one component to accomplish bonding, it is restricted to webs with two components like conjugate fibers or those which include an adhesive. In the through-air bonder, air having a temperature above the melting temperature of one component and below the melting temperature of another component is directed from a surrounding hood, through the web, and into a perforated roller supporting the web. Alternatively, the through-air bonder may be a flat arrangement wherein the air is directed onto and through the web. The operating conditions of the two configurations are similar, the primary difference being the geometry of the web during bonding. The hot air melts the lower melting polymer component and thereby forms bonds between the filaments to integrate the web.

As used herein “thermal point bonding” involves passing a fabric or web of fibers to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30 percent bond area with about 200 bonds/square inch as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen Pennings or “EHP” bond pattern which produces a 15 percent bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15 percent. Yet another common pattern is the C-Star pattern which has a bond area of about 16.9 percent. The C-Star pattern has a cross-directional bar or “corduroy” design interrupted by shooting stars. Other common patterns include a diamond pattern with repeating and slightly offset diamonds with about a 16 percent bond area and a wire weave pattern looking as the name suggests, e.g. like a window screen, with about a 19 percent bond area. Typically, the percent bonding area varies from around 10 percent to around 30 percent of the area of the fabric laminate web. As is well known in the art, the spot bonding holds the laminate layers together as well as imparts integrity to each individual layer by bonding filaments and/or fibers within each layer.

As used herein, the term “bonding window” means the range of temperature of the mechanism, e.g. calender rolls, used to bond the nonwoven fabric together, over which such bonding is successful. For polypropylene spunbond, this bonding window is typically from about 270° F. to about 310° F. (132° C. to 154° C.). Below about 270° F. the polypropylene is not hot enough to melt and bond and above about 310° F. the polypropylene will melt excessively and can stick to the calender rolls. Polyethylene has an even narrower bonding window.

As used herein, the term “surfactant” is a substance that acts by modifying the surface or boundary between two phases and is also referred to as a “surface-active agent”. These substances are compounds that reduce surface tension when present, in very small amount (≦0.01 Molar) in water or water solutions, or which reduce interfacial tension between two liquids, or between a liquid and a solid. A wide variety of substances that may be surface active in aqueous media have common features. For example, their molecular structures are composed of at least two distinct functional portions, namely one being hydrophilic (a water soluble polar head) and the other one being lypophilic (an oil soluble apolar tail). The lypophilic portion is usually a long hydrocarbon chain of about 6 carbons or more. These molecules are surface active because when dissolved in water they have tendency to migrate or adsorb at liquid/air, liquid/liquid or solid/liquid interfaces. There is a large variety of surfactants which can broadly be classified in 5 categories: 1) Anionic: these are ionized salts where the anion (e.g. carboxylate, sulfate, sulfonate, etc) is attached to a long alkyl chain; 2) Cationic: these are surfactants bearing a positively charged group (e.g. ammonium group) attached to along alkyl chain; 3) Non-ionic: these are polyether derivatives made from ethoxylation reactions (e.g. ethoxylated hydrogenated castor oil); 4) Amphoteric: these are surfactants that can be either cationic or anionic depending on pH (e.g. N-dodecyl-N:N dimethyl betaine); 5) Polymeric: these may consist of any of the previous categories, but are much larger molecular weights, for example higher than about 1200.

As used herein, the term “wetting agent” is a product that acts by modifying the wetting characteristics of a solid surface and includes any compound that promotes water wettability of a solid material. Generally, there are two means to promote water wettability: (1) increasing surface energy of the solid substrate to a level that at least equals the surface tension of water and (2) reducing the surface tension of the water to at least equal the surface energy of the solid substrate. The latter means of promoting wettability, reducing the surface tension of water by at least about 20 dynes/cm is achieved by surfactants. Increasing the surface energy of solid substrates can be achieved by several means including wet chemistry using coating of surfaces with water soluble high molecular weight polymers, radiation-induced graft copolymerization of hydrophilic monomers onto solid surfaces, or dry processes such as flame treatment, corona glow discharge and plasma glow discharge.

Test Methods

Skin Hydration Test

Skin hydration values are determined by measuring TransEpidermal Water Loss (TEWL) and can be determined by employing the following test procedure. The test is conducted on adults on the forearm. Any medications should be reviewed to ensure they have no effect on test results and the subject's forearms should be free of any skin conditions such as rashes or abrasions. Subjects should relax in the test environment, which should be at about 72° F. (22° C.) with a humidity of about 40 percent, for about 15 minutes prior to testing and movement should be kept to a minimum during testing. Subjects should wear short sleeve shirts, not bathe or shower for about 2 hours before testing, and should not apply any perfumes, lotions, powders, etc., to the forearm.

The measurements are taken with an evaporimeter, such as a DERMALAB® instrument distributed by Cortex Technology, Textilvaenget 1 9560 Hadsund Denmark.

A baseline reading should be taken on the subject's midvolar forearm and should be less than 10 g/m²/hr. Each test measurement is taken over a period of two minutes with TEWL values taken once per second (a total of 120 TEWL values).

The end of a dispensing tube is placed on the mid-forearm for carrying out the test. The eye of the tube should be facing the target loading zone. A product to be tested is placed on the subject's forearm directly over the end of the tube. The product may vary depending upon the type of material to be tested or material availability so care should be taken to ensure that test results are comparable. A stretchable net such as that available from, Sturgilast Tublar Elastic Dressing Retainer Western Medical should be placed over the product to help to hold it in place.

Three equal loadings of 70 ml of 0.9 weight percent of NaCl aqueous solution available from VWR Scientific Products at about 95° F.+/−5° F. (35° C.) are delivered to the product at an interval of 45 seconds at a rate of 300 mils/minute by a pump such as a MASTERFLEX LS®) pump. After 60 minutes, the product is removed from the subject's forearm and Evaporimeter readings taken immediately on the skin at the subjects midvolar forearm where the product had been. TransEpidermal Water Loss values are reported as the difference between the one hour and baseline values in g/m²/hr.

Water Vapor Transmission Rate Test

A suitable technique for determining the WVTR (water vapor transmission rate) value of a material is the test procedure standardized by INDA (Association of the Nonwoven Fabrics Industry), number IST 70.4 (99), entitled “STANDARD TEST METHOD FOR WATER VAPOR TRANSMISSION RATE THROUGH NONWOVEN AND PLASTIC FILM USING A GUARD FILM AND VAPOR PRESSURE SENSOR” which is incorporated by reference herein. The INDA procedure provides for the determination of WVTR, the permeance of the film to water vapor and, for homogeneous materials, water vapor permeability coefficient.

The INDA test method is well known and will not be set forth in detail herein. However, the test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the Permatran-W model 100K manufactured by Mocon/Modern Controls, Inc, Minneapolis, Minn. A first test is made of the WVTR of the guard film and air gap between an evaporator assembly that generates 100 percent relative humidity. Water vapor diffuses through the air gap and the guard film and then mixes with a dry gas flow which is proportional to water vapor concentration. The electrical signal is routed to a computer for processing. The computer calculates the transmission rate of the air gap and guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. The computer then calculates the transmission rate of the combination of the air gap, the guard film, and the test material. This information is then used to calculate the transmission rate in units of grams/square meter/24 hours (g/m²/24 hr) at which moisture is transmitted through the test material.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents.

The present invention relates to a nonwoven material adapted for use as a surge layer or a transfer layer that includes fibers at least a portion of which have been treated with a polysaccharide, a modified polysaccharide, a derivative of a polysaccharide or a derivative of a modified polysaccharide or a combination or mixture thereof. In an exemplary embodiment, the present invention provides a treated fibrous nonwoven surge layer for a personal care absorbent article that has improved wettability while minimizing the use of surfactants and surfactant chemistry, i.e. reducing the surface tension of the insulting liquid. Unexpectedly, the treated fibrous nonwoven surge layer also reduces skin hydration as measured by TransEpidermal Water Loss (TEWL). The use of wet chemistries is preferred in this application. A combination of water-soluble polymer with a small amount of surfactant is suggested as long as the surface tension of an aqueous insult is reduced by no more than 20 dynes/cm.

Exemplary personal care absorbent articles include, but are not limited to, diapers, training pants, incontinence garments, sanitary napkins, absorbent pads, surgical drapes, bandages and so forth. Personal care absorbent articles typically include a liquid permeable body-side liner and a liquid impermeable backing layer or baffle with an absorbent core disposed therebetween. As discussed in the background, a common problem with many of these products and their designs is the fact that they will not accept rapid and/or multiple insults of body fluids or exudates such as menses and urine in a sufficiently short period of time without leaking. This is particularly true as designs of these products strive to be thinner to present discrete appearance. In an attempt to overcome this problem, many product designs have included some sort of additional layer between the body-side liner and the absorbent core to act as a dash pot of sorts to temporarily absorb, hold and then discharge the particular body exudate taken in through the liner. An additional problem with many of these products and their designs is the fact that they have a tendency to cause the skin of the wearer to be over hydrated possibly contributing to skin health issues. Skin hydration can be due to excessive fluid flowing back from the absorbent core towards the skin of the wearer or to excess moisture in the diaper environment. Fluid flowback can be due to excess amount of surfactant that lowers the surface tension of the insult fluid in such a way that fluid flows back easily, under minimum pressure, from the inner absorbent core towards the outer layers facing the skin of a diaper wearer. Less surfactant is also desired because less surfactant will minimize or eliminate any negative effects on the swelling behavior of the superabsorbing particles present in the absorbent core. For example, if a superabsorbent material is used in or as the second layer of the substrate, rapid or substantially immediate degradation will limit the amount of gel blocking which occurs because the non-degraded surfactant will allow the fluid to be absorbed into the superabsorbent particles faster than that of a fluid which contains no surfactant. Furthermore, as a superabsorbent particle swells it forms a gel which tends to block flow of fluid into and around the particle. Therefore, if the particle has swollen to capacity and the gel from the particle has been formed such that fluid cannot pass into or around the particle, then the fluid will often pool above the area which is blocked by the gel. Further still, where gel blocking has occurred, the material which fluid would otherwise access through the gelled portion of material will have to find an alternative route to that material or it will not be used. In either event the efficiency of the absorbency of the material has been reduced. Therefore, desirable embodiments of the present invention minimize skin hydration and thus promote skin health without compromising the primary fluid handling functions of a personal care product such as a diaper.

The present invention provides a fibrous nonwoven surge layer that provides an effective means for temporarily storing and then distributing body exudates when incorporated into a personal care absorbent article or product. A fibrous nonwoven surge layer of the present invention includes a layer of nonwoven fibers that includes fibers that have been treated with a polysaccharide, a modified polysaccharide, a derivative of a polysaccharide or a derivative of a modified polysaccharide. In certain desirable embodiments, the body facing surface of the topsheet layer of nonwoven fibers is surfactant free and does not include fibers that have been treated with a surfactant. Personal care articles typically include and are made from synthetic materials that are not inherently wettable, such as polyethylene, polypropylene or polyester resins. These non-wettable materials are frequently treated with surfactants to improve the wettability of the materials. The present invention provides a wettability treatment for inherently non-wettable materials, such polyolefins, that eliminates, or at least reduces, the use of surfactants in personal care articles and other absorbent articles. It has been alleged that many conventional surfactants may be irritating or sensitizing to human skin for at least a percentage of the population. Examples of such irritation or sensitizing surfactants include, but are not limited to, ionic and cationic surfactants such as alkyl sulfate, alkyl ammonium salts and the like. It would be particularly desirable to eliminate the inclusion of such surfactants in components of such articles that will contact or will be near skin.

Generally, surfactants modify the surface or boundary between two phases and by reducing surface tension when dissolved in water or water solutions. Surfactants have a lypophilic tail of six carbon atoms or more and a hydrophilic head. The hydrophilic head and a lypophilic tail of the surfactant molecule are attracted to hydrophilic and hydrophobic species, respectively, and act to reduce the surface tension at a boundary of hydrophilic species(s) and hydrophobic specie(s), for example urine and a polyolefin nonwoven substrate. Excessive levels of surfactants may contribute to skin health issues because surfactants can penetrate the natural barrier provided by the stratum corneum and thus provide a path for irritation of the viable skin cells under the stratum corneum. In addition, surfactants can have detrimental effects on the functions of the superabsorbent material present in the absorbent core. Surfactants can also promote fluid flowback under pressure and thus can negatively impact skin dryness.

The present invention provides a surge layer that is treated with a water-soluble polymer so that the surface tension of the contacting aqueous fluid, for example urine, is reduced by no more than 20 dynes/cm. Examples of such a treated surge material exhibit improved dryness. One example of such a surge layer includes fibers that are treated with a polysaccharide, a modified polysaccharide, a derivative of a polysaccharide or a derivative of a modified polysaccharide and a portion of fibers that are not treated with a polysaccharide, a modified polysaccharide, a derivative of a polysaccharide or a derivative of a modified polysaccharide. It is believed that the polysaccharide, modified polysaccharide, derivative of a polysaccharide or derivative of a modified polysaccharide acts as a moisture and/or water trap to promote dryness as measured by an unexpected decrease in TEWL. Optionally a suitable crosslinking agent can be added to the formulation containing the modified polysaccharide prior to application to the fibers in order to control the solubility of the polysaccharide polymer to the desired level and obtain greater control over the extent of limiting the reduction in surface tension of the aqueous liquid or urine.

Generally, a polysaccharide is a natural polymer having glucose as repeating units. The polysaccharide may have a plurality of hydrophobic groups and a plurality of hydrophilic groups. The hydrophobic groups may be ═CH— and —CH₂— groups in the polysaccharide backbone. The hydrophobic groups may be adapted to provide an affinity of the polysaccharide for the hydrophobic polymer of which the porous substrate is composed and the hydrophilic groups may be adapted to modify the chemical and/or physical properties of the polysaccharide. Examples of polysaccharides include, but are not limited to, natural gums, such as agar, agarose, carrageenans, furcelleran, alginates, locust bean gum, gum arabic, guar gum, gum konjac, and gum karaya; microbial fermentation products, such as gellan gum, xanthan gum, and dextran gum; cellulose, such as microcrystalline cellulose and high molecular weight water-soluble cellulose and high molecular weight water-soluble cellulose derivatives; and animal products, such as hyaluronic acid, heparin, chitin, chitosan and so forth. Examples of derivatives of polysaccharides include, but are not limited to, carboxymethyl cellulose, hydroxypropyl cellulose, hydroxyethyl cellulose, ethyl hydroxyethyl cellulose and so forth. Natural polymers such as the above-listed polysaccharides and polysaccharide derivatives differ from surfactants because these natural polymers derivatives do not have the molecular structural characteristics of a conventional surfactant and do not significantly reduce surface tension of water as conventional surfactants do. In addition, polysaccharides have tendency to strongly adsorb onto synthetic fibers and thus do not readily migrate to the aqueous phase upon exposure to an aqueous fluid, unlike most surfactants. Polysaccharides also have a tendency to strongly bind water molecules and thus act as dehydrating agents, especially in an occlusive diaper environment. The water binding tendency can be further optimized using suitable crosslinking agents for the polysaccharide. The crosslinking agents can be either synthetic or natural based materials capable of interacting with the polysaccharide and render it crosslinked.

The polysaccharide treatment of the present invention may be or include a modified polysaccharide. A modified polysaccharide may have a plurality of hydrophobic groups and a plurality of hydrophilic groups. The hydrophobic groups may be ═CH— and —CH₂— groups in the polysaccharide backbone, or pendant groups. The hydrophilic groups also may be pendant groups. The term “pendant” used herein with respect to the hydrophobic or other groups means that such groups are attached to the polymer backbone but are not part of it. Thus, removal of the pendant groups will not alter the chemical structure of the backbone. Again, the hydrophobic groups may be adapted to provide an affinity of the polysaccharide for the hydrophobic polymer of which the porous substrate is composed and the hydrophilic groups may be adapted to render the polysaccharide hydrophilic. By way of illustration only, examples of modified polysaccharides include, but are not limited to, modified celluloses or cellulose derivatives, such as hydroxyethyl cellulose, hydroxypropyl cellulose, methyl cellulose, ethyl cellulose, methyl hydroxypropyl cellulose, ethyl hydroxyethyl cellulose, and carboxymethyl cellulose; starch and pectin derivatives, such as carboxymethyl starch, starch aldehyde, and pectates; and animal product derivatives, such as carboxymethyl chitin and carboxymethyl chitosan and so forth.

Particularly useful types of polysaccharides and modified polysaccharides include, by way of illustration, agar; alginates; and modified celluloses, such as ethyl hydroxyethyl cellulose (EHEC), hydroxy propyl cellulose (HPC) and so forth. In certain embodiments, a portion of the fibers are treated with EHEC or HPC or derivatives of EHEC or HPC or any combination thereof. In modified polysaccharides, particularly in the useful type of modified polysaccharides just noted, the hydrophobic groups may be pendant monovalent alkyl groups. For example, such hydrophobic groups may be methyl or ethyl groups. As a further example, the hydrophilic groups may be pendant monovalent hydroxyalkyl groups. As yet another example, such hydrophilic groups may be hydroxyethyl groups. Particularly suggested polysaccharides include ethyl hydroxyethyl celluloses sold by Akzo Nobel of Strafford, Conn. under the tradename BERMOCOLL EBS E481 FQ and BERMOCOLL E230 FQ. BERMOCOLL EBS E481 FQ is a high molecular weight ethyl hydroxyethyl cellulose derivative. A general chemical formula for the BERMOCOLL cellulose derivatives is 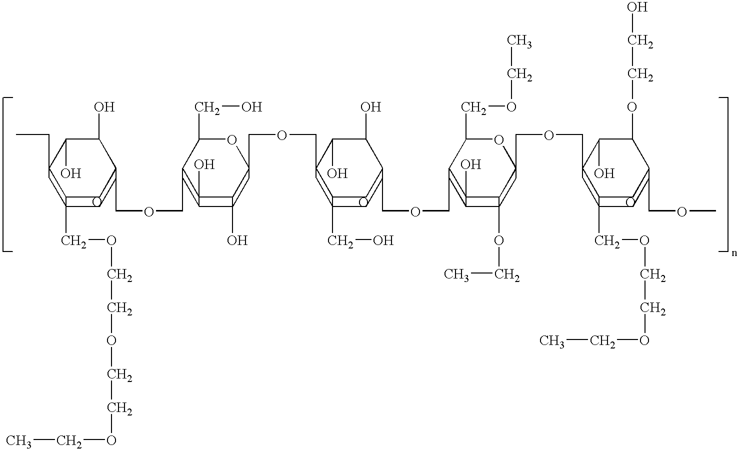
which have an average degree of polymerization (n) ranging from 300 to 2600 (n ranges from about 300 to about 2600). BERMOCOLL E230 FQ has an average degree of polymerization (n) of about 300. BERMOCOLL EBS E481 FQ has an average degree of polymerization (n) of 2600. Other ethyl hydroxyethyl cellulose derivatives produced by Akzo Nobel include BERMOCOLL EHM 100 and BERMOCOLL EHM 200, which are both cellulose derivatives analog to BERMOCOLL E230 FQ having alkyl chains of more than two carbons. Other cellulose derivatives and suggested examples include, but are not limited to, hydroxypropyl cellulose available from Hercules of Wilmington, Del. under the trade name of Klucel® HPC and is a cellulose derivative analog to BERMOCOLL E230 FQ having alkyl chains of more than two carbons.

The fibers treated with a polysaccharide, a modified polysaccharide, a derivative of a polysaccharide or a derivative of a modified polysaccharide or a combination thereof can be treated using known methods of treating fibers. Desirably, the fibers are treated before being incorporated into a web or combined with other fibers into a web. Suggested methods of treating the fibers with a polysaccharide, a modified polysaccharide, a derivative of a polysaccharide or a derivative of a modified polysaccharide include, but are not limited to, saturation, spray, slot die, printing, foaming, and combinations and modifications thereof.

The fibers can be treated with the polysaccharide, modified polysaccharide, derivative of a polysaccharide, derivative of a modified polysaccharide or combination thereof using any known process for surface treating fibers including, but not limited to, a saturation process. In a saturation process, tows of fiber bundles are dipped in a bath containing the treating solution. Fibers are impregnated with treating solution and excess solution can optionally be removed by nipping between nip rolls. Alternatively, the treating solution is sprayed onto a tow of fibers followed by drying. The tows of fibers can be treated one time or several times in consecutive steps if desired. Also a combination of processes can also be used such as for example a saturation step followed by a spray of same or different chemical.

As previously stated, a fibrous nonwoven web of the present invention can be used as a surge layer or as a transfer layer disposed between the body-side liner and the absorbent core of an absorbent article, for example a diaper. A surge layer is most typically placed between and in contact with the body-side liner and the absorbent core though other additional layers may be incorporated into the overall product design if so desired. To further enhance fluid transfer, it is desirable that the fibrous nonwoven web surge layer be attached to the layers directly above and below its exterior surfaces. To this end, suitable attachment means include, but are not limited to, adhesives (water-based, solvent-based and thermally activated adhesives), thermo bonding, ultrasonic bonding, needling and pin aperturing as well as combinations of the foregoing or other appropriate attachment means. A transfer layer is also most typically placed between and in contact with the absorbent core of an absorbent article and transfers fluid between two layers, but typically has lower capacity or surge volume compared to surge material. A transfer layer is configured to increase the rate of liquid absorption by the article and reduce the flowback of absorbed liquid against the skin of the wearer. Transfer layers are described in detail in U.S. Pat. No. 5,192,606 which is hereby incorporated by reference herein.

The following description will be made in the context of a disposable diaper article which is adapted to be worn by infants about the lower torso. It is readily apparent, however, that the absorbent article of the present invention would also be suitable for use as other types of absorbent articles, for example: training pants, absorbent underpants, incontinence products and devices, feminine hygiene products, absorbent pads, mortuary products, veterinary products, wound dressings and bandages, hygiene products and so forth.

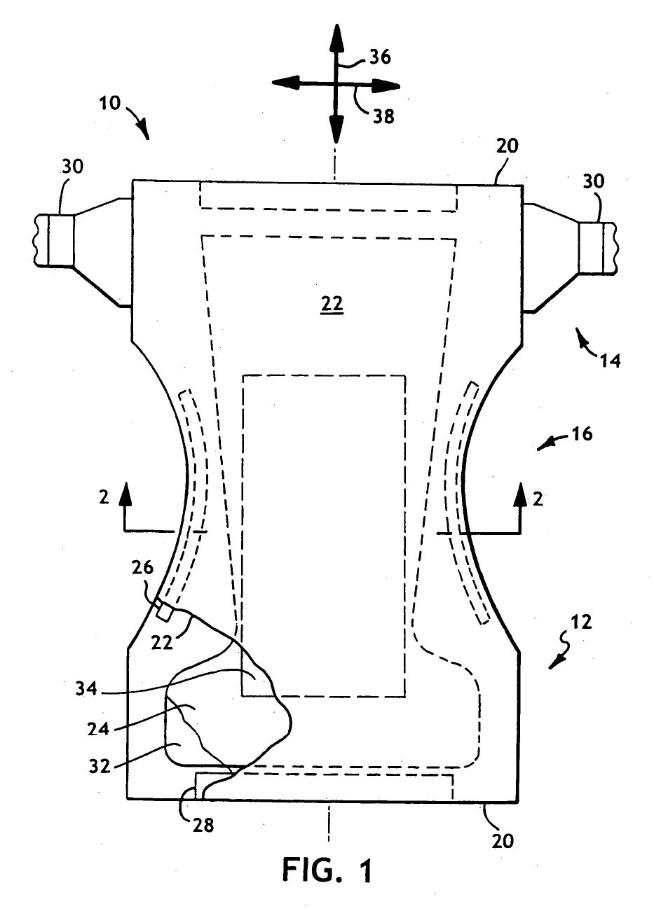

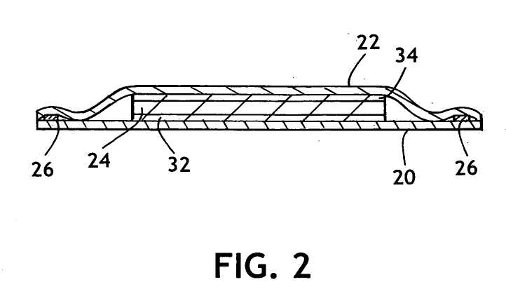

Examples of suitable constructions of absorbent articles for use in the present invention are described below and representatively illustrated in FIGS. 1 and 2. FIG. 1 is a representative plan view of an integral absorbent garment article, such as disposable diaper 10, of the present invention in its flat-out, uncontracted state (i.e., with all elastic induced gathering and contraction removed). Portions of the structure are partially cut away to more clearly show the interior construction of diaper 10, and the surface of the diaper which contacts the wearer is facing the viewer. FIG. 2 representatively shows a sectional view of the absorbent article of FIG. 1 taken along line 2-2. With reference to FIGS. 1 and 2, the disposable diaper 10 generally defines a front waist section 12, a rear waist section 14, and an intermediate section 16 which interconnects the front and rear waist sections. The front and rear waist sections include the general portions of the article which are constructed to extend substantially over the wearer's front and rear abdominal regions, respectively, during use. The intermediate section of the article includes the general portion of the article which is constructed to extend through the wearer's crotch region between the legs.

The absorbent article may include a vapor permeable backsheet 20, a liquid permeable topsheet 22 positioned in facing relation with the backsheet 20, and an absorbent body 24, such as an absorbent pad, which is located between the backsheet 20 and the topsheet 22. The backsheet 20, also referred to as an outercover, defines a length and a width which, in the illustrated embodiment, coincide with the length and width of the diaper 10. The absorbent body 24 generally defines a length and width which are less than the length and width of the backsheet 20, respectively. Thus, marginal portions of the diaper 10, such as marginal sections of the backsheet 20, may extend past the terminal edges of the absorbent body 24. In the illustrated embodiments, for example, the backsheet 20 extends outwardly beyond the terminal marginal edges of the absorbent body 24 to form side margins and end margins of the diaper 10. The topsheet 22 is generally coextensive with the backsheet 20 but may optionally cover an area which is larger or smaller than the area of the backsheet 20, as desired. The backsheet 20 and topsheet 22 are intended to face the garment and body of the wearer, respectively, while in use. The permeability of the backsheet is configured to enhance the breathability of the absorbent article to reduce the hydration of the wearer's skin during use without allowing excessive condensation of vapor, such as urine, on the garment facing surface of the backsheet 20 which can undesirably dampen the wearer's clothes.

To provide improved fit and to help reduce leakage of body exudates from the diaper 10, the diaper side margins and end margins may be elasticized with suitable elastic members, such as single or multiple strands of elastic as is known. The elastic strands may be composed of natural or synthetic rubber and may optionally be heat shrinkable or heat elasticizable. For example, as representatively illustrated in FIGS. 1 and 2, the diaper 10 may include a matching pair of leg elastics 26 which are constructed to operably gather and shirr the side margins of the diaper 10 to provide elasticized leg bands which can closely fit around the legs of the wearer to reduce leakage and provide improved comfort and appearance. Similarly, waist elastics 28 can be employed to elasticize the end margins of the diaper 10 to provide elasticized waists. The waist elastics front and back, are configured to operably gather and shirr the waist sections to provide a resilient, comfortably close fit around the waist of the wearer. In the illustrated embodiments, the elastic members are illustrated in their uncontracted, stretched condition for the purpose of clarity.

Fastening means, such as hook and loop fasteners 30, are employed to secure the diaper on a wearer. Alternatively, other fastening means, such as buttons, pins, snaps, adhesive tape fasteners, cohesives, mushroom-and-loop fasteners, or the like, may be employed. The diaper 10 may further include other layers between the absorbent body 24 and the topsheet 22 or backsheet 20. For example, as representatively illustrated in FIGS. 1 and 2, the diaper 10 may include a ventilation or spacer layer 32 located between the absorbent body 24 and the backsheet 20 to insulate the backsheet 20 from the absorbent body 24 to improve air circulation and effectively reduce the dampness of the garment facing surface of the backsheet 20. The ventilation layer 32 may also assist in distributing fluid exudates to portions of the absorbent body 24 which do not directly receive the insult. The diaper 10 may also include a surge management layer 34 located between the topsheet 22 and the absorbent body 24 to prevent pooling of the fluid exudates and further improve air exchange and distribution of the fluid exudates within the diaper 10.

The diaper 10 may be of various suitable shapes. For example, the diaper may have an overall rectangular shape, T-shape or an approximately hour-glass shape. In the shown embodiment, the diaper 10 has a generally I-shape. The diaper 10 further defines a longitudinal direction 36 and a lateral direction 38. Other suitable diaper components which may be incorporated within absorbent articles of the present invention include containment flaps, waist flaps, elastomeric side panels, and the like which are generally known to those skilled in the art. Examples of diaper configurations suitable for use in connection with the instant application which may include other diaper components suitable for use on diapers are described in U.S. Pat. No. 4,798,603 issued Jan. 17, 1989, to Meyer et al.; U.S. Pat. No. 5,176,668 issued Jan. 5, 1993, to Bernardin; U.S. Pat. No. 5,176,672 issued Jan. 5, 1993, to Bruemmer et al.; U.S. Pat. No. 5,192,606 issued Mar. 9, 1993, to Proxmire et al., and U.S. Pat. No. 5,509,915 issued Apr. 23, 1996 to Hanson et al., the disclosures of which are herein incorporated by reference in their entirety.

The various components of the diaper 10 may be integrally assembled together employing various types of suitable attachment means, such as adhesive, sonic bonds, thermal bonds or combinations thereof. In the shown embodiment, for example, the topsheet 22 and backsheet 20 are assembled to each other and to the absorbent body 24 with lines or swirls of adhesive, such as a hot melt, pressure-sensitive adhesive. Similarly, other diaper components, such as the elastic members 26 and 28, fastening members 30, and ventilation and surge layers 32 and 34 may be assembled into the diaper article by employing the above-identified attachment mechanisms.

The backsheet 20 of the diaper 10, as representatively illustrated in FIGS. 1 and 2, is typically composed of a substantially vapor permeable material. The backsheet 20 may be generally constructed to be permeable to at least water vapor and may have a water vapor transmission rate of at least about 800 g1 m²/24 hr., desirably at least about 1500 g/m²/24 hr, more desirably at least about 3000 g/m²/24 hr., and even more desirably at least about 6000 g/m²/24 hr. For example, the backsheet 20 may define a water vapor transmission rate of from about 800 to about 15000 g/m²/24 hr. Materials which have a water vapor transmission rate less than those above usually do not allow a sufficient amount of air exchange and can undesirably result in increased levels of skin hydration if no other means of humidity reduction within the diaper is available. The backsheet 20 is also desirably substantially liquid impermeable to minimize strike through of liquids, such as urine, during use.

The backsheet 20 may be composed of any suitable materials which either directly provide liquid impermeability and air permeability with the above desired levels or, in the alternative, materials which can be modified or treated in some manner to provide such levels. The backsheet 20 may be a nonwoven fibrous web constructed to provide liquid impermeability, for example, a nonwoven web composed of spunbonded or meltblown polymer fibers may be selectively treated with a water repellent coating or laminated with a liquid impermeable, vapor permeable polymer film to provide the backsheet 20. Particularly, the backsheet 20 may comprise a nonwoven web composed of a plurality of randomly deposited hydrophobic thermoplastic meltblown fibers which are sufficiently bonded or otherwise connected to one another to provide a substantially vapor permeable and substantially liquid impermeable web. The backsheet 20 may also comprise a vapor permeable nonwoven layer which has been partially coated or otherwise configured to provide liquid impermeability in selected areas.

Examples of suitable materials for the backsheet 20 are also described in U.S. Pat. No. 5,482,765 issued Jan. 9, 1996 in the name of Bradley et al. and entitled “Nonwoven Fabric Laminate With Enhanced Barrier Properties”; U.S. Pat. No. 5,879,341 issued Mar. 9, 1999 in the name of Odorzynski et al. and entitled “Absorbent Article Having A Breathability Gradient”; U.S. Pat. No. 5,843,056 issued Dec. 1, 1998, in the name of Good et al. and entitled “Absorbent Article Having A Composite Breathable Backsheet”; and U.S. Pat. No. 6,309,736 issued Oct. 30, 2001, in the name of McCormack et al. and entitled “Low Gauge Films And Film/Nonwoven Laminates”, the disclosures of which are herein incorporated by reference in their entirety.

In a particular embodiment of a diaper, the backsheet 20 is provided by a highly breathable laminate and more particularly by a microporous film/nonwoven laminate material comprising a spunbond nonwoven material laminated to a microporous film. The spunbond nonwoven comprises filaments of about 1.8 denier extruded from polypropylene and defines a basis weight of from about 17 to about 25 g/m². The film comprises a cast coextruded film having calcium carbonate-filled linear low polyethylene microporous core and ethylene vinyl acetate and Catalloy™ polypropylene (Catalloy™ 357P), available from Basell (having offices in Wilmington, Del.), blended skin layer having a basis weight of about 58 g/m² prior to stretching. The film is preheated, stretched and annealed to form the micropores and then laminated to the spunbond nonwoven. The resulting microporous film/nonwoven laminate based material has a basis weight of from about 30 to about 60 g/m² and a water vapor transmission rate of from about 800 to about 15,000 g/m²/24 hr. Examples of such film/nonwoven laminate materials are described in more detail in U.S. Pat. No. 6,309,736 issued Oct. 30, 2001, in the name of McCormack et al. and entitled “Low Gauge Films And Film/Nonwoven Laminates,” the disclosure of which was incorporated by reference above.

The topsheet 22, as representatively illustrated in FIGS. 1 and 2, suitably presents a bodyfacing surface which is compliant, soft feeling, and nonirritating to the wearer's skin. Further, the topsheet 22 may be less hydrophilic than the absorbent body 24, to present a relatively dry surface to the wearer, and may be sufficiently porous to be liquid permeable, permitting liquid to readily penetrate through its thickness. A suitable topsheet 22 may be manufactured from a wide selection of web materials, such as porous foams, reticulated foams, apertured plastic films, natural fibers (for example, wood or cotton fibers), synthetic fibers (for example, polyester or polypropylene fibers), or a combination of natural and synthetic fibers. The topsheet 22 is suitably employed to help isolate the wearer's skin from liquids held in the absorbent body 24.

Various woven and nonwoven fabrics can be used for the topsheet 22. For example, the topsheet may be composed of a meltblown or spunbonded web of polyolefin fibers. The topsheet may also be a bonded-carded web composed of natural and/or synthetic fibers. The topsheet may be composed of a substantially hydrophobic material, and the hydrophobic material may, optionally, be treated with a surfactant or otherwise processed to impart a desired level of wettability and hydrophilicity. In a particular embodiment of the present invention, the topsheet 22 comprises a nonwoven spunbond, polypropylene fabric composed of from about 2.2 to about 2.8 denier fiber formed into a web having a basis weight of about 17 g/m² and a density of about 0.11 gram per cubic centimeter. Such a topsheet 22 may be surface treated with an effective amount of a surfactant such as about 0.3 weight percent of a surfactant commercially available from Uniqema under the trade designation AHCOVEL BASE N-62. In one suggested embodiment, the topsheet is treated on one surface, the surface facing the surge layer and interior of the diaper, with a 3:1 mixture of AHCOVEL BASE N-62 surfactant and GLUCOPON 220 UP surfactant in a manner so that no or a minimal amount of surfactant is on the body contacting surface of the topsheet. Details of a one-sided treated material and a one-sided, foam treatment method are disclosed in commonly assigned U.S. patent application Ser. No. ______, entitled “Porous Substrates Having One Side Treated At A Higher Concentration And Methods Of Treating Porous Substrates” filed by Express Mail Procedure EL 439721061 U.S. contemporaneously herewith and which is hereby incorporated by reference herein. The topsheet can be untreated. Desirably, the topsheet is a 0.5 osy nonwoven fabric of 2.7 denier polypropylene fibers treated on one side with a high viscosity foam that consists of about 18 weight percent of AHCOVEL BASE N-62 surfactant and GLUCOPON 220 UP surfactant at a 3 to 1 ratio in water. A foam can be generated from the 3:1 AHCOVEL BASE N-62/GLUCOPON 220 UP surfactant solution by mixing the surfactant and water solution at high speed until a uniform and small cell size foam is produced from the components of the solution.

In another desirable embodiment, the topsheet 22 is treated with a non-surfactant chemistry that does not depress water by at least about 20 dynes/cm at a concentration of 0.01 molar or with a minimal amount of surfactants or surfactant chemistry. Accordingly, in one embodiment, no surfactant will be added to or incorporated into the topsheet of the present invention. However, in an alternative embodiment, the liner or topsheet 22 of the diaper 10 may also be treated with a surfactant to promote wettability of the liner, thereby promoting the wicking of moisture away from the surface of the user's skin and improved skin health conditions. Additionally, one or more skin health agents may be included in the diaper, for example on the topsheet 22 or surge management material 34. Skin health agents include any compound, composition or formulation that is or includes a compound that is or can be used to protect, repair, moisturize or otherwise provide relief to damaged or undamaged skin. Such skin health agents include but are not limited to polydimethyl siloxane compounds, alkyl silicones, phenyl silicones, amine-functional silicones, silicone gums, silicone resins, silicone elastomers, dimethicones, dimethicone copolyols and lipids and derivatives thereof and botanical extracts, emollients, clay particles, talc particles, boron nitride particles, corn starch, zeolites, zinc oxide, glycerin and related polyols, hyaluronic acid, chitosan and chemically-modified sulfated chitosans.

As noted above, in an alternative embodiment incorporating a surfactant, the fabric of the topsheet 22 may be surface treated with about 0.3 weight percent of a surfactant mixture which contains a mixture of AHCOVEL Base N-62 and GLUCOPON 220 UP surfactant in a 3:1 ratio based on a total weight of the surfactant mixture. Other possible classes of surfactants include MASIL SF 19 and DC 193 Surfactant. The AHCOVEL Base N-62 is purchased from Uniqema (a division of ICI, and having offices in New Castle, Del.), and includes a blend of hydrogenated ethoxylated castor oil and sorbitan monooleate. The GLUCOPON 220 UP is purchased from Cognis Corporation and includes an alkyl polyglycoside. MASIL SF 19 and DC 193 surfactant are purchased from BASF of Mount Olive, N.J., and Dow Corning of Midland, Mich., respectively. MASIL SF 19 and DC 193 Surfactant are examples of typical ethoxylated polyalkylsiloxanes. The surfactant may be applied by any conventional means, such as saturation, spraying, printing, roll transfer, slot coating, brush coating, internal melt addition or the like. The surfactant may be applied to the entire topsheet 22 or may be selectively applied to particular sections of the topsheet 22, such as the medial section along the longitudinal centerline of the diaper, to provide greater wettability of such sections.

The absorbent body 24 of the diaper 10, as representatively illustrated in FIGS. 1 and 2, may suitably comprise a matrix of hydrophilic fibers, such as a web of cellulosic fluff, mixed with particles of a high-absorbency material commonly known as superabsorbent material. In a particular embodiment, the absorbent body 24 comprises a matrix of cellulosic fluff, such as wood pulp fluff, and superabsorbent hydrogel-forming particles. The wood pulp fluff may be exchanged with synthetic, polymeric, meltblown fibers or with a combination of meltblown fibers and natural fibers. The superabsorbent particles may be substantially homogeneously mixed with the hydrophilic fibers or may be nonuniformly mixed. Alternatively, the absorbent body 24 may comprise a laminate of fibrous webs and superabsorbent material or other suitable means of maintaining a superabsorbent material in a localized area.

The absorbent body 24 may have any of a number of shapes. For example, the absorbent core may be rectangular, I-shaped, or T-shaped. It is generally desired that the absorbent body 24 be narrower in the intermediate section than in the front or rear waist sections of the diaper 10. The absorbent body 24 may be provided by a single layer or, in the alternative, may be provided by multiple layers, all of which need not extend the entire length and width of the absorbent body 24. In the illustrated embodiment, the absorbent body 24 is generally T-shaped with the laterally extending cross-bar of the “T” generally corresponding to the front waist section 12 of the absorbent article for improved performance, especially for male infants. In the illustrated embodiments typical of a diaper that will fit a baby weighing from about 22 to 37 pounds, for example, the absorbent body 24 across the front waist section 12 of the article has a cross-directional width of about 16 centimeters, the narrowest portion of the intermediate section 16 has a width of about 9 centimeters and in the rear waist section 14 has a width of about 11 centimeters.

The size and the absorbent capacity of absorbent body 24 should be compatible with the size of the intended wearer and the liquid loading imparted by the intended use of the absorbent article. Further, the size and the absorbent capacity of the absorbent body 24 can be varied to accommodate wearers ranging from infants through adults. In addition, it has been found that with the present invention, the densities and/or basis weights of the absorbent body 24 can be varied. In a particular aspect of the invention, the absorbent body 24 has an absorbent capacity of at least about 300 grams of physiological saline. Suggested absorbent bodies includes a combination of hydrophilic fibers and high-absorbency particles, the hydrophilic fibers and high-absorbency particles can form a basis weight in the primary insult area of the product for the absorbent body 24 which is within the range of about 600 to about 1300 g/m². Suggested fiber/particle composite basis weights in the primary insult area of the product of such an absorbent body 24 are within the range of about 600 to about 1200 g/m², and desirably are within the range of about 800 to about 1150 g/m² to provide the desired performance.

To provide the desired thinness dimension to the various configurations of the absorbent article of the invention, the absorbent body 24 can be configured with a bulk thickness which is not more than about 0.8 centimeters. Desirably, the bulk thickness is not more than about 0.6 centimeters, and more desirably is not more than about 0.5 centimeters to provide improved benefits. The bulk thickness is determined under a restraining pressure of 0.2 psi (1.38 kPa). The high-absorbency or superabsorbent material can be selected from natural, synthetic, and modified natural polymers and materials. The high-absorbency materials can be inorganic materials, such as silica gels, or organic compounds, such as crosslinked polymers. Examples of synthetic, polymeric, high-absorbency materials include, but are not limited to, the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrolidone), poly(vinyl morpholinone), poly(vinyl alcohol), and mixtures and copolymers thereof. Further polymers suitable for use in the absorbent core include natural and modified natural polymers, such as hydrolyzed acrylonitrile-grafted starch, acrylic acid grafted starch, methyl cellulose, carboxymethyl cellulose, hydroxypropyl cellulose, and the natural gums, such as alginates, xanthum gum, locust bean gum, and the like. Mixtures of natural and wholly or partially synthetic absorbent polymers can also be useful in the present invention.

The high absorbency material may be in any of a wide variety of physical forms. As a general rule, it is desired that the high absorbency material be in the form of discrete particles. However, the high absorbency material may also be in the form of fibers, flakes, rods, spheres, needles, or the like. In general, the high absorbency material is present in the absorbent body in an amount of from about 5 to about 90 weight percent, desirably in an amount of at least about 30 weight percent, and even more desirably in an amount of at least about 40 weight percent based on a total weight of the absorbent body 24. For example, the absorbent body 24 may comprise a laminate which includes at least in part, and desirably at least about 40 weight percent and more desirably at least about 70 weight percent of high-absorbency material overwrapped by a fibrous web or other suitable means of maintaining the high-absorbency material in a localized area. An example of high-absorbency material suitable for use in the present invention is HYSORB® 8800 polymer available from BASF of Mount Olive N.J. Other suitable superabsorbents may include, but are not limited to, DRYTECH® 2035M available from Dow Chemical Co. located in Midland, Mich., or FAVOR SXM 9543 polymer obtained from Stockhausen, a business having offices in Greensboro, N.C.

Optionally, a tissue or synthetic nonwoven wrapsheet (not illustrated) may be employed to help maintain the integrity of the structure of the absorbent body 24. The tissue wrap sheet or barrier layer is typically placed about or on top of the absorbent body and may be composed of an absorbent cellulosic material, such as creped wadding or a high wet-strength tissue. In one aspect of the invention, the tissue wrap or barrier layer can be configured to provide a wicking layer which helps to rapidly distribute liquid over the mass of absorbent fibers comprising the absorbent body.

In addition, the absorbent body 24 may further include a plurality of zones of high air permeability (not shown) which allow air and vapors to readily pass through the absorbent body 24 and through the vapor permeable backsheet 20 out of the diaper 10 into ambient air. A more detailed description and discussion of exemplary unitary components may be found in U.S. Pat. No. 6,152,906 issued Nov. 28, 2000 to Faulks et al.; U.S. Pat. No. 6,238,379 issued May 29, 2001, to Keuhn et al.; and U.S. Pat. No. 6,287,286 issued on Sep. 11, 2001 to Akin et al., the disclosures of which are incorporated by reference in their entirety.

As in conventional absorbent articles, due to the thinness of absorbent body 24 and the presence of high absorbency material within the absorbent body 24, the liquid uptake rates of the absorbent body 24, by itself, may be too low, or may not be adequately sustained over multiple insults of liquid into the absorbent body 24. To improve the overall liquid uptake and air exchange, a diaper of the present invention may include the previously mentioned additional porous, liquid-permeable layer of surge management material 34, as representatively illustrated in FIGS. 1 and 2. The surge management layer 34 is typically less hydrophilic than the absorbent body 24, and has an operable level of density and basis weight to quickly collect and temporarily hold liquid surges, to transport the liquid from its initial entrance point and to substantially completely release the liquid to other parts of the absorbent body 24. This configuration can help prevent the liquid from pooling and collecting on the portion of the absorbent garment positioned against the wearer's skin, thereby reducing the feeling of wetness by the wearer. The structure of the surge management layer 34 also generally enhances the air exchange within the diaper 10.

Various woven and nonwoven fabrics can be used to construct the surge management layer 34. For example, the surge management layer 34 may be a bonded-carded-web or an airlaid web composed of natural and synthetic fibers. The bonded-carded-web may, for example, be a thermally bonded web which is bonded using low melt binder fibers, powder or adhesive. The webs can optionally include a mixture of different fibers. Alternatively, the surge management layer 34 may be a layer composed of a meltblown or spunbonded web of synthetic fibers, such as polyolefin fibers. The surge management layer 34 may be composed of a substantially hydrophobic material, and the hydrophobic material may optionally be treated with a surfactant or otherwise processed to impart a desired level of wettability and hydrophilicity. In certain embodiments, the surge management layer 34 includes a hydrophobic, nonwoven material having a basis weight of from about 20 to about 150 g/m² that is treated to reduce the hydrophobicity of the nonwoven material.

For example, in a particular embodiment, the surge management layer 34 may comprise a bonded-carded-web, nonwoven fabric which includes bicomponent fibers and which defines an overall basis weight of about 76 g/m². The surge management layer 34 in such a configuration can be a homogeneous blend composed of about 60 weight percent polyethylene/polyester (PE/PET) or polyethylene/polypropylene (PE/PP), sheath-core bicomponent fibers which have a fiber denier of from about 1 d to about 3 d and about 40 weight percent single component polyester fibers which have a fiber denier of about 6 d and which have fiber lengths of from about 3.8 to about 5.1 centimeters. Examples of such bicomponent staple fibers include T-258 1.5 denier fibers from KoSa Fibers of Salisbury, N.C. and T-215A 1.7 d fibers from Fibervisions of Athens, Ga. The bicomponent fibers are desirably coated with a coating that includes from about 0.05 to about 0.25 weight percent add-on of BERMOCOL E230FQ or BERMOCOL EBS 481 FQ, about 0.10 weight percent of an antistatic agent and about 0.1 weight percent of a lubricant such as a combination of sorbitan monooleate and ethoxylated, hydrogenated castor oil. Examples of such polyester fibers include T-295 6.0 denier fibers from KoSa Fibers. The polyester fibers are desirably coated with a combination of fatty esters including sorbitan monooleate; ethoxylated hydrogenated castor oil and polyethylene glycol-400-monolaurate.

In the illustrated embodiments, the surge management layer 34 is desirably arranged in a direct, contacting liquid communication fashion with the absorbent body 24. The surge management layer 34 may be operably connected to the topsheet 22 with a conventional pattern of adhesive, such as a swirl adhesive pattern. In addition, the surge management layer 34 may be operably connected to the absorbent body 24 with any other pattern of adhesive. The amount of adhesive add-on should be sufficient to provide the desired levels of bonding, but should be low enough to avoid excessively restricting the movement of liquid from the topsheet 22, through the surge management layer 34 and into the absorbent body 24.

The absorbent body 24 is desirably positioned in liquid communication with surge management layer 34 to receive liquids released from the surge management layer, and to hold and store the liquid. The surge management layer 34 serves to quickly collect and temporarily hold discharged liquids, to transport such liquids from the point of initial contact and spread the liquid to other parts of the surge management layer 34, and then to substantially completely release such liquids into the layer or layers comprising the absorbent body 24.

The surge management layer 34 can be of any desired shape. Suitable shapes include for example, circular, rectangular, triangular, trapezoidal, oblong, dog-boned, hourglass-shaped, or oval. In certain embodiments, for example, the surge management layer can be generally rectangular-shaped. In the illustrated embodiments, the surge management layer 34 extends over a part of the absorbent body 24 and is centered about the longitudinal centerline 36 of the absorbent body 24. The surge management layer 34 is placed toward the front waist section 12 of the diaper 10 and extends beyond the intermediate section 16 of the diaper 10. Alternatively, the surge management layer 34 may be selectively positioned anywhere along the absorbent body 24 or may be coextensive with the absorbent body 24.

Additional materials suitable for the surge management layer 34 are set forth in U.S. Pat. No. 5,486,166 issued Jan. 23, 1996 in the name of Ellis et al. and entitled “Fibrous Nonwoven Web Surge Layer For Personal Care Absorbent Articles And The Like”; U.S. Pat. No. 5,490,846 issued Feb. 13, 1996 in the name of Ellis et al. and entitled “Improved Surge Management Fibrous Nonwoven Web For Personal Care Absorbent Articles And The Like”; and U.S. Pat. No. 5,364,382 issued Nov. 15, 1994 in the name of Latimer et al. and entitled “Absorbent Structure Having Improved Fluid Surge Management And Product Incorporating Same”, the disclosures of which are hereby incorporated by reference in their entirety. These additional exemplary materials can include fibers, all or a portion of which, have been treated with a treatment composition that includes a polysaccharide, a modified polysaccharide, a derivative of a polysaccharide or a derivative of a modified polysaccharide, wherein the treatment composition on the surge layer reduces the surface tension of an aqueous fluid by less than about 20 dynes/cm as measured by ASTM Test Method D 1590-60.

Nonwoven materials of the present invention that are suggested for use as a surge material include, but are not limited to, bonded carded webs having a basis weight that is in the range of from about 20 to about 150 grams per square meter. An exemplary bonded carded web of the present invention includes, but is not limited to, a single-layer through-air bonded carded web of a homogeneous blend of: (1) 60 weight percent of 1.5 denier bicomponent fiber including a polyethylene sheath/polypropylene core surface treated with a 0.10 percent by weight solution of BERMOCOLL E230 FQ ethyl hydroxyethyl cellulose and (2) 40 weight percent of untreated 6 denier polyester staple fibers. Both fibers can be obtained from KoSa of Salisbury, N.C. Other suggested web materials of the present invention include blends of: (1) 60 weight percent ESC 233A HR6 3.0 denier bicomponent fiber including a polyethylene sheath/polypropylene core, commercially available from ES Fibervisions in Athens, Ga. or Type 256 3.0 denier bicomponent fiber including a polyethylene sheath/polyester core, commercially available from KoSa of Salisbury, N.C., both of which are surface treated with a polysaccharide, a modified polysaccharide, a derivative of a polysaccharide or a derivative of a modified polysaccharide; and (2) 40 weight percent Type 295 6 denier polyester staple fiber, commercially available from KoSa. Another suitable surge material has a basis weight of about 20 to about 150 grams per square meter, and comprises a through-air bonded carded web of homogenous blend of: (1) 60 weight percent ESC 215A HR6 1.5 denier bicomponent fiber including a polyethylene sheath/polypropylene core, commercially available from ES Fibervision or Type 256 2.0 denier bicomponent fiber including a polyethylene sheath/polyester core, commercially available from KoSa both of which are surface treated with a polysaccharide, a modified polysaccharide, a derivative of a polysaccharide or a derivative of a modified polysaccharide and (2) 40 weight percent 3 denier polyester staple fiber, commercially available from KoSa. The treated fibers and the untreated fibers may be of the same type and composition or may differ in composition or other parameter such as denier or length. The treatment may further include processing aids such as lubricant and anti-static agents to ease the carding process.

Suggested fibers include most synthetic staple fibers that are typically used for making fibrous webs in disposable personal care articles including, but not limited to, thermoplastic fibers, most synthetic staple fibers, polyolefin fibers, natural fibers and so forth. Fiber cross sections may be either circular or noncircular including, for example bilobal, trilobal, and X-shaped cross-sections. The fibers may be solid or hollow. In addition they may be made from a single fiber polymer or from multiple polymers such as are commonly found in biconstitutent and bi- or multicomponent fibers. When using bicomponent fibers, fiber cross-sections may include, for example, sheath/core, side-by-side and islands-in-the-sea cross-sections. The resultant fibrous nonwoven web will be a uniformly mixed homogenous single layer blend of whatever type fiber or fibers are chosen. In addition, a portion of all of the fibers may be crimped. Crimping can be imparted both mechanically and chemically thereby forming both zig-zag or sawtooth and helically or spirally crimped fibers.

The processes used to form the fibrous nonwoven web include those which will result in a material which, as further described below, has a defined range of physical properties. Suitable processes may include, but are not limited to, airlaying, spunbonding, bonded carded web formation and coform processes. Spunbond nonwoven webs are made from fibers which are formed by extruding a molten thermoplastic material as filaments from a plurality of fine capillaries in a spinneret with the diameter of the extruded filaments then being rapidly reduced, for example, by non-eductive or eductive fluid-drawing or other well known spunbonding mechanisms. The production of spunbonded nonwoven webs is illustrated in patents such as U.S. Pat. No. 4,340,563 to Appel, et al.; U.S. Pat. No. 3,692,61 to Dorschner et al.; U.S. Pat. Nos. 3,338,992 and 3,341,394 to Kinney; U.S. Pat. No. 3,276,944 to Levy; U.S. Pat. No. 3,502,538 to Peterson; U.S. Pat. No. 3,502,763 to Hartman; U.S. Pat. No. 3,542,615 to Dobo et al.; and Canadian Patent No. 803,714 to Harmon, which are all hereby incorporated herein by reference in their entirety.

Bonded carded webs are made from staple fibers which are usually purchased in bales. The staple fibers are taken from one or more of these bales and sent through opening and blending equipment and then through one or more carding units where the staple fibers are further separated and partially aligned in the machine direction. The resulting carded web can be combined with one or more additional carded webs or can be laid in a folded pattern and fed through one or more additional cards to form a more unidirectional web. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding. One of the advantages of through-air bonding is the ability to control the level of compression or collapse of the structure during the formation process. In through-air bonding, heated air is forced through the web to melt and bond together the fibers at their crossover points. Typically the unbonded web is supported on a forming wire or drum. In addition a vacuum may be pulled through the web if so desired to further contain the fibrous web during the bonding process.

Airlaying is another well known process by which fibrous nonwoven webs according to the present invention can be made. In the airlaying process, bundles of small fibers usually have lengths ranging between about 6 and about 19 millimeters are separated and entrained in an air supply and then deposited onto a forming screen, oftentimes with the assistance of a vacuum supply. The randomly deposited fibers are then bonded to one another using, for example, hot air or a spray adhesive. A portion of the fibers forming the web must be can from polymers which are heat bondable. By heat bondable it is meant that the randomly deposited fibers forming the nonwoven web can be subjected to heat or ultrasonic energy of a sufficient degree that the fibers will adhere to one another at the fiber cross over points due to the melting or partial softening of the polymer forming the heat bondable fibers. Suitable polymers for forming such heat bondable fibers are permanently fusible and are typically referred to as being thermoplastic. Examples of suitable thermoplastic polymers include, but are not limited to, polyolefins, polyesters, polyamides, orlon, acetates and polyvinyl alcohol as well as homopolymers, copolymers and blends. Optionally, wetting agents and/or surfactants may be added either internally, such as with siloxane during the fiber spinning process, or externally as a post treatment either to the fibers and/or the resultant web as with a low level ionic or nonionic surfactants including ethoxylated hydrocarbons, siloxanes and fluorocarbons in such a way that surface tension of an insult is not reduced by more than 20 dynes/cm. Such wetting agents/surfactants as well as their use are well known and need not be described herein in detail.

The fibers formed from the aforementioned polymers may be cut staple length fibers such as are used in the airlaying and the bonding and carding processes or uncut more continuous fibers as are formed in, for example, the spunbond process. Typical cut staple fiber lengths will range between about 38 and about 51 millimeters, though lengths outside this range also may be used. For example, airlaying typically involves using fibers with cut lengths in the range of about 6 to about 19 millimeters. Fiber diameters will range between about 1.0 and about 16 denier with the target range being between about 1.5 and about 6 denier.

To facilitate the through-air bonding process, it has been found advantageous to use bicomponent fibers which have both a higher melting point and lower melting point component such as in a side-by-side, sheath/core or islands-in-the-sea configurations. The lower melting point component or polymer of the bicomponent fibers provides an efficient means for bonding the fibers together while the higher melting point component aids in maintaining the structural rigidity and the openness of the material both in the dry and wet states. Suitable bicomponent fibers include, for example, whether in staple fiber or more continuous spunbond form, polyethylene/polypropylene and polyethylene/polyester fibers. The fibrous nonwoven web according to the present invention may be made entirely from bicomponent fibers or it may be made from a blend of bicomponent fibers and other fibers such as single component fibers including polyesters, nylons, rayons and polyolefins such as polypropylene. It also may be made exclusively from single component fibers. Generally, the fibrous nonwoven web according to this embodiment of the present invention will include at least 50 percent by weight bicomponent fibers, based upon the total weight of the web. Such bicomponent fibers will typically have an average denier equal to or greater than 1.5 denier.

In order to demonstrate the properties of the present invention, a series of materials were formed and then tested. In addition, samples of these materials were then placed within diaper constructions and tested for TEWL and surface tension depression properties. The test procedures, materials and test results are set forth below.

### EXAMPLES

All of the following examples were prepared using conventional carding equipment and were subsequently through-air bonded at temperatures and times sufficient to cause the lower melting point component of the bicomponent fibers to at least partially melt and bond to one another at their cross-over points.

### Control Example

The control example was a HUGGIES Ultratrim Size 4 diaper that included a surge layer that consisted of a bonded carded web having a basis weight of about 101 gsm formed from a uniform blend of 60 weight percent of 1.5 denier staple fibers that included polyethylene sheath and a polypropylene core and 40 weight percent of 6 denier poly(ethylene terephthalate) staple fibers. Both fibers were obtained from KoSa of Salisbury, N.C. The poly(ethylene terephthalate) fibers were pretreated with a 0.55 weight percent solution of a blend of ethoxylated, hydrogenated castor oil and sorbitan monooleate (referred to as L-1 finish). The treatment may also include other processing aids such as commonly available lubricant and anti-static agents to ease the carding process.

### Example 1

A single-layer, bonded carded web having a basis weight of approximately 101 g/m² was formed from a uniform blend of 60 weight percent of 1.5 denier bicomponent fibers pretreated with a 0.10 weight percent solution of BERMOCOLL EBS E481 FQ ethyl hydroxyethyl cellulose (EHEC) and 40 weight percent of 6 denier poly(ethylene terephthalate) staple fibers. The bicomponent fibers consisted of 45 weight percent of a polyethylene sheath and 55 weight percent of a polypropylene core that were pretreated with a 0.55 weight percent solution of a blend of ethoxylated, hydrogenated castor oil and sorbitan monooleate. Both sets of fibers were obtained from KoSa of Salisbury, N.C.

This bonded carded web was then inserted between the body-side liner and the absorbent core of a HUGGIES Ultratrim Size 4 diaper for evaluation. The materials were then tested on human subjects for TransEpidermal Water Loss using the test procedure described and using three outercovers having range of WVTR breathability as measure in units of g/m²/24 hr. The first and least breathable diaper included an outercover with a WVTR breathability of 885 g/m²/24 hr. The second more breathable diaper included an outer cover with a WVTR breathability of 9055 g/m²/24 hr. And, the third and most breathable diaper included an outercover with a WVTR breathability of 14,460 g/m²/24 hr. Twenty test subjects participated in the arm-band TEWL study. Diapers were applied to the arm and three insults of 70 mis of saline solution at a rate of 300 ml/min were applied at 45 seconds apart. The test subjects wore the armbands for 60 minutes and baseline and final TEWL readings were completed using the Dermalab Evaporimeter. Averages of the test results are provided in Table 1 below.

TABLE 1
Skin Hydration Value As Measured By TEWL
of Diaper Constructions Versus Control Examples

| | | | |
|---|---|---|---|
| OUTER COVER | WVTR | WVTR | WVTR |
| BREATH- | 855 g/m²/24 hr | 9055 g/m²/24 hr | 14,460 g/m²/24 hr |
| ABILITY | | | |
| CONTROL | | | |
| EXAMPLES | | | |
| w/conventionally | 40.3 g/m²/hour | 26.4 g/m²/hour | 25.9 g/m²/hour |
| treated surge | | | |
| layer | | | |
| w/EHEC treated | 36.3 g/m²/hour | 22.0 g/m²/hour | 18.9 g/m²/hour |
| surge layer | | | |
| Decrease in skin | 4.0 g/m²/hour | 4.4 g/m²/hour | 7.0 g/m²/hour |
| hydration | | | |
| (TEWL) | | | |

The diapers that included a surge layer in which fibers had been treated with BERMOCOL EBS E481 FQ ethyl hydroxyethyl cellulose (EHEC) showed significantly decreased skin hydration as measured by TEWL improvement versus diapers that included conventionally treated surge layers. The amount of liquid evaporating from the skin decreased by 4 g/m²/hour in the low breathability diaper example and decreased by 7 g/m²/hour in the high breathability diaper example.

Diapers that included a surge layer containing EHEC-treated fibers showed improved skin dryness as exhibited by a consistent reduction in TEWL compared to diapers containing a similar bonded carded surge layer that was treated with a conventional surfactant system.

### Example 2

Additionally, another example was prepared that included a single-layer, bonded carded web having a basis weight of approximately 76 g/m² formed of a uniform blend of 60 weight percent of 1.5 denier bicomponent fibers pretreated with a 0.10 weight percent solution of BERMOCOLL EBS E481 FQ ethyl hydroxyethyl cellulose (EHEC) and 40 weight percent of 6 denier poly(ethylene terephthalate) staple fibers pretreated with a 0.55 weight percent solution of a blend of ethoxylated, hydrogenated castor oil and sorbitan monooleate. The bicomponent fibers consisted of 45 weight percent of a polyethylene sheath and 55 weight percent of a polypropylene core. Both fibers were obtained from KoSa of Salisbury, N.C.

Using a HUGGIES Ultratrim Size 4 diaper with an outercover WVTR of approximately 1500 g/m²/24 hr, the bonded carded web was inserted between the absorbent body and a topsheet having a single sided surfactant treatment that faced the surge management layer. To produce the single-sided top sheet, a foamable surface treatment solution was prepared. The treatment solution consisted of about 18 weight percent aqueous solution of a 3:1 blend of AHCOVEL Base N-62 surfactant obtained from Uniqema a division of ICI having offices in New Castle, Del. and GLUCOPON 220 UP surfactant available from Cognis Corporation of Ambler, Pa. The solution was subjected to high shear mixing using a GASTON Systems equipment CFS from Gaston Systems, Inc. of Stanley, N.C. with a built-in mixer set at 600 rpm for about 30 minutes to generate a uniform and small cell size foam from the components of the solution. The foam was then immediately smeared via a parabolic applicator having ⅛″ slot opening onto one side of a sample of spunbond liner material. The add-on level of the treatment composition can be controlled by varying bath concentration, flow rate of the treatment composition through the applicator onto the material to be treated and/or line speed of the material to be treated among other variables. The add-on level was about 0.25 weight percent.

The liner was subsequently dried in a hot air dryer by directing heated air at both surfaces of the liner but by directing more air toward the surface of the liner that was not treated so that the flow of heated air was greater on the untreated side of the liner, thus, minimizing soak through of the treatment composition to the untreated side of the liner. The base material for the topsheet was a 0.5 osy spunbond liner made from Exxon PP 3155 polypropylene resin that can be obtained from Kimberly-Clark Corporation.

In an additional code, only the body-side liner was replaced with the single sided treated liner. These material combinations and a control code were tested on human subjects for TransEpidermal Water Loss using the test procedure described. The TEWL data is presented in Table 2 below.

TABLE 2

| Topsheet Layer | Surge Management Layer | |
|---|---|---|
| Treatment | Treatment | TEWL |
| Control | Control | 40.8 g/m²/hr |
| Single-sided | Control | 34.9 g/m²/hr |
| Single-sided | EHEC | 31.9 g/m²/hr |

Results indicate the single sided topsheet treatment to reduce skin hydration as measured by TEWL by 5.9 g/m²/hr. The experimental surge management layer reduced TEWL by an additional 3.0 g/m²/hr for an additive total of 8.9 g/m²/hr. Both the topsheet treatment and surge management treatment provided improved skin hydration performance.

Other embodiments may include a combination of staple fibers that are treated with EHEC along with a small amount of a surfactant system in such a way that surface tension of incoming aqueous insult is not reduced by more than 20 dynes/cm as illustrated in Table 3, below. The examples in Table 3 that included a polysaccharide derivative, BERMOCOLL EBS E481 FQ or BERMOCOLL E230 FQ, and an antistat included the polysaccharide derivative and the antistat at a 3:1 ratio, that is 3 parts by weight polysaccharide derivative to 1 part by weight antistat. The reported add-on is the total add on of both components. The antistats were applied to the fibers by the fiber supplier.

TABLE 3
Surface Tension Of Water Following Exposure
To Various Treated Surge Materials

| | Surface tension |
|---|---|
| Example description | (dynes/cm) |
| Control example 40% T-295/60% T-258 | 54 |
| 40% T-295/60% TL836A - E481 with no Antistat | 58 |
| 40% T-295/60% TL836L - E481 with Antistat 1 at | 61 |
| 0.10% add-on | |
| 40% T-295/60% TL836HM - E230 with Antistat 1 at | 56 |
| 0.10% add-on | |
| 40% T-295/60% TL836KM - E230 with Antistat 2 at | 58 |
| 0.10% add-on | |
| 40% T-295/60% TL836GM - E230 with Antistat 1 at | 60 |
| 0.06% add-on | |
| 40% T-295/60% TL836I - E230 with Antistat 1 at | 61 |
| 0.15% add-on | |
| 40% T-295/60% TL836J - E230 with Antistat 1 at | 59 |
| 0.20% add-on | |

Test method: The surface tension (ST) of water exposed to materials identified in Table 2, was determined by cutting up 1.0 gram of nonwoven into approximately 1 inch squares and placing in a 250 ml beaker and adding 100 ml of deionized water at room temperature (about 25° C.). The sample was stirred mildly by hand with a glass stirring rod for one minute and the liquid was decanted into a container suitable for measuring surface tension according to ASTM Test Method D 1590-60 using a Fisher Tensiometer (Fisher Scientific Company, Pittsburg, Pa.). As a reference, surface tension of water prior to coming in contact with the treated materials is about 71 dynes/cm. These results demonstrate that surface tension of a typical aqueous insult fluid is not significantly lowered by contacting a treated surge material. Minimizing the reduction in surface tension is important because minimizing the surface tension can minimize negative of surfactants on: 1) the superabsorbing material in absorbent core of a diaper, 2) fluid flow back under pressure as in a situation where the baby sits down while the diaper is already wet, and/or 3) capillarity and fluid movement in porous structures.

Although various embodiments of the invention have been described above using specific terms, devices, and methods, such description is for illustrative purposes only. The words used are words of description rather than of limitation. It is to be understood that changes and variations may be made by those of ordinary skill in the art without departing from the spirit or scope of the present invention, which is set forth in the following claims. In addition, it should be understood that aspects of the various embodiments may be interchanged both in whole or in part. Therefore, the spirit and scope of the appended claims should not be limited to the description of the preferred versions contained therein.

1. A nonwoven material adapted for use as a surge layer or a transfer layer comprising at least a first portion of first fibers that have been treated with a treatment composition comprising a polysaccharide, a modified polysaccharide, a derivative of a polysaccharide or a derivative of a modified polysaccharide, wherein the treatment composition on the surge layer or the transfer layer fibers reduces the surface tension of distilled water by less than about 20 dynes/cm as measured by ASTM Test Method D 1590-60.

2. The nonwoven material of claim 1, wherein the nonwoven material further comprises a second portion of second fibers that have not been treated with a polysaccharide, a modified polysaccharide, a derivative of a polysaccharide or a derivative of a modified polysaccharide.

3. The nonwoven material of claim 1, wherein the first portion of first fibers have been treated with a modified polysaccharide.

4. The nonwoven material of claim 1, wherein the layer of nonwoven fibers is a bonded, carded web having a basis weight in the range of from about 20 grams per square meter to about 150 grams per square meter and comprises greater than about 20 weight percent of the first fibers and greater than about 10 weight percent of the second fibers.

5. The nonwoven material of claim 1, wherein the layer of nonwoven fibers comprises greater than about 30 weight percent of the first fibers and greater than about 20 weight percent of the second fibers.

6. The nonwoven material of claim 1, wherein the layer of nonwoven fibers comprises greater than about 40 weight percent of the first fibers and greater than about 30 weight percent of the second fibers.

7. The nonwoven material of claim 1, wherein the layer of nonwoven fibers comprises greater than about 50 weight percent of the first fibers and greater than about 30 weight percent of the second fibers.

8. The nonwoven material of claim 1, wherein the layer of nonwoven fibers consists essentially of from about 30 weight percent to about 80 weight percent of the first fibers and from about 20 weight percent to about 70 weight percent of the second fibers.

9. The nonwoven material of claim 1, wherein the first fibers are treated with a lubricant or an antistatic agent.

10. The nonwoven material of claim 2, wherein the first fibers and the second fibers are treated with a lubricant or an antistatic agent.

11. The nonwoven material of claim 1, wherein the first fibers comprise cellulosic fibers polyolefin fibers, polyester fibers, polyamide fibers, poly(lactic acid) fibers, or fibers of copolymers thereof.

12. The nonwoven material of claim 1, wherein the first fibers are bicomponent polyolefin fibers that comprise a polypropylene core and a polyethylene sheath.

13. The nonwoven material of claim 1, wherein the polysaccharide, the modified polysaccharide, the derivative of a polysaccharide or the derivative of a modified polysaccharide is selected from the group consisting of modified celluloses, cellulose derivatives, hydroxyethyl cellulose, hydroxypropyl cellulose, methyl cellulose, ethyl cellulose, methyl hydroxypropyl cellulose, ethyl hydroxyethyl cellulose, carboxymethyl cellulose; starch derivatives, pectin derivatives, carboxymethyl starch, starch aldehyde, pectates, animal product derivatives, carboxymethyl chitin and carboxymethyl chitosan.

14. The nonwoven material of claim 1, wherein the polysaccharide, the modified polysaccharide, the derivative of a polysaccharide and the derivative of a modified polysaccharide is selected from the group consisting of hydroxyethyl cellulose, hydroxypropyl cellulose, methyl cellulose, ethyl cellulose, methyl hydroxypropyl cellulose, ethyl hydroxyethyl cellulose, and carboxymethyl cellulose.

15. An absorbent article comprising the nonwoven material of claim 1.

16. A diaper comprising the nonwoven material of claim 1.

17. A method of forming a layer of nonwoven fibers comprising:
a. providing a plurality of first fibers
b. treating the plurality of first fibers with a polysaccharide, a modified polysaccharide, a derivative of a polysaccharide or a derivative of a modified polysaccharide;
c. providing a plurality of second fibers,
d. combining the first fibers with the second fibers to form a mixture that comprises the first fibers and the second fibers,
e. forming a nonwoven web from the mixture that comprises the first fibers and the second fibers.

18. The method of claim 17 wherein forming a nonwoven web from the mixture that comprises the first fibers and the second fibers comprises carding and bonding the first fibers and the second fibers to form a web.

19. A diaper comprising a surge layer or a transfer layer comprising fibers treated with a polysaccharide, a modified polysaccharide, a derivative of a polysaccharide or a derivative of a modified polysaccharide wherein the treated surge layer or transfer layer modifies the surface tension of distilled water to about 56 dynes/cm or greater as measured by ASTM Test Method D 1590-60 and the treatment of the fibers of the surge layer or a transfer layer reduces the surface tension of distilled water by less than about 20 dynes as measured by ASTM Test Method D 1590-60.

20. The diaper of claim 19 wherein the treated surge layer or transfer layer modifies the surface tension of distilled water to about 58 dynes/cm or greater as measured by ASTM Test Method D 1590-60.

21. The diaper of claim 19 wherein the treated surge layer or transfer layer modifies the surface tension of distilled water to about 60 dynes/cm or greater as measured by ASTM Test Method D 1590-60.

22. The diaper of claim 19, wherein the diaper has a TEWL value of less than about 37 g/m²/hour.

23. The diaper of claim 19 having a TEWL reduction of at least about 3 g/m²/hr compared to a diaper of the same construction but with the surge layer including fibers not treated with a polysaccharide, a modified polysaccharide, a derivative of a polysaccharide or a derivative of a modified polysaccharide.

24. The diaper of claim 19, further comprising an outer cover with a WVTR less than 20,000 g/m²/24 hr.

25. An absorbent article comprising:
a. a porous, treated substrate comprising a first surface that comprises a first amount of a surfactant or mixture of surfactants and a second surface that comprises a second amount of the surfactant or the mixture of surfactants wherein the second amount of the surfactant or the mixture of surfactants is less than the first amount of the surfactant or the mixture of surfactants; and
b. a layer of nonwoven fibers comprising fibers treated with a polysaccharide, a modified polysaccharide, a derivative of a polysaccharide or a derivative of a modified polysaccharide.

26. The absorbent article of claim 25, wherein the first surface of the porous, treated substrate is oriented toward or adjacent the layer of nonwoven fibers treated with a polysaccharide, a modified polysaccharide, a derivative of a polysaccharide or a derivative of a modified polysaccharide.

27. The absorbent article of claim 25, wherein the porous, treated substrate further comprises a skin health agent.

28. The absorbent article of claim 25, wherein the layer of nonwoven fibers comprising fibers treated with a polysaccharide, a modified polysaccharide, a derivative of a polysaccharide or a derivative of a modified polysaccharide is a spunbonded web or a bonded carded web of fibers treated with ethyl hydroxyethyl cellulose, hydroxypropyl cellulose or a mixture thereof.

29. The absorbent article of claim 25, wherein the second surface of the porous, treated substrate contains essentially no surfactant.

30. The absorbent article of claim 25, wherein the porous, treated substrate is a single layer.

31. The absorbent article of claim 25, wherein the TEWL of the absorbent article including combination of the porous treated substrate and the layer of treated nonwoven fibers is less than the TEWL of an absorbent article that includes only one of the porous, treated substrate or the layer of treated nonwoven fibers.

32. The absorbent article of claim 25, wherein the TEWL of the absorbent article is reduced by at least about 3 g/m²/hr compared to a diaper of the same construction but with the surge layer not including fibers treated with a polysaccharide, a modified polysaccharide, a derivative of a polysaccharide or a derivative of a modified polysaccharide.

33. A bonded carded web adapted for use as a surge layer or a transfer layer having a basis weight of from about 50 to about 200 grams per square meter and comprising polyethylene sheath/polypropylene core fibers bicomponent fibers that have been treated with a treatment composition that comprises a polysaccharide, a modified polysaccharide, a derivative of a polysaccharide or a derivative of a modified polysaccharide, wherein the treatment composition on the bicomponent fibers reduces the surface tension of distilled water by less than about 20 dynes/cm as measured by ASTM Test Method D 1590-60.

34. A diaper comprising a surge layer that is a bonded carded web having a basis weight of from about 50 to about 200 grams per square meter wherein the bonded carded web comprises fibers that have been treated with a treatment composition that comprises a polysaccharide, a modified polysaccharide, a derivative of a polysaccharide or a derivative of a modified polysaccharide, wherein the treatment composition on the fibers reduces the surface tension of distilled water by less than about 20 dynes/cm as measured by ASTM Test Method D 1590-60.
